(19) United States
(12) Patent Application Publication
(10) Pub. No.: US 2025/0100051 A1
(43) Pub. Date: Mar. 27, 2025

(54) METHOD AND DEVICE FOR ADDITIVELY MANUFACTURING AN OBJECT

(71) Applicant: Technische Universität München, München (DE)

(72) Inventors: Tobias Abstreiter, Lengdorf (DE); Daniel Weger, Reichersbeuern (DE)

(73) Assignee: Technische Universität München, München (DE)

(21) Appl. No.: 18/832,700

(22) PCT Filed: Feb. 9, 2023
(86) PCT No.: PCT/EP2023/053205

§ 371 Date: Jul. 24, 2024

(30) Foreign Application Priority Data
Feb. 9, 2022 (EP) 22155978.4

(51) Int. Cl. B22F 10/22; B22F 10/25; B22F 12/13; B29C 64/118; B29C 64/295; B33Y 10/00; B33Y 30/00

(52) U.S. Cl. CPC B22F 10/22; B22F 10/25; B22F 12/13; B29C 64/118; B29C 64/295; B33Y 10/00; B33Y 30/00

(57) ABSTRACT

This disclosure relates to a method for the additive manufacturing of an object, including supplying a strand-shaped starting material to a friction arrangement, and accelerating the starting material along an output direction through the friction arrangement, to apply the starting material onto a construction platform and/or onto already manufactured areas of the object for manufacturing the object, wherein the starting material is at least partially liquefied and/or at least partially plasticized and/or at least partially broken down into particles by the friction arrangement. This disclosure also relates to a manufacturing device to perform such methods.

### CROSS REFERENCE TO RELATED APPLICATIONS

This application is a US national stage filing under 35 U.S.C. § 371 of International Application No. PCT/EP2023/053205, filed Feb. 9, 2023, which claims priority to European Patent Application No. 22155978.4, filed Feb. 9, 2022, each of which is incorporated herein by reference in its entirety.

### TECHNICAL FIELD

This disclosure relates to a method for the additive manufacturing of an object and a manufacturing device for the additive manufacturing of an object. In additive manufacturing, the object is built up in layers from a starting material. This is also referred to as 3D printing.

### BACKGROUND

3D printing applications are known from the prior art. In particular, such techniques are also being tested in the production of concrete components. For example, concrete is applied to a surface in layers to produce a desired structure. However, under bending loads, concrete components require reinforcement, which must be inserted into the concrete component. The Wire Arc Additive Manufacturing (WAAM) process, for example, is known for the additive manufacturing of reinforcement, in which the reinforcement is produced in layers using arc welding. According to the prior art, the reinforcement is produced layer by layer in several layers in advance before the concrete is applied in layers.

However, arc welding requires an electrical contact, for example, to an electrical ground connection outside the component or to the already manufactured reinforcement as a ground connection. This represents an additional production step and thus an increased effort and results in higher costs. In addition, a lot of heat is introduced into the reinforcement during the welding process and thus into the concrete layers, which are usually not yet fully cured. There is therefore a risk of negative effects on the concrete. The layer-by-layer application of the welding layers to produce the reinforcement also often leads to disadvantageous material properties of the reinforcement.

A method for producing a reinforced concrete component is known from WO 2020/193150 A1. For this method, concrete is extruded in the form of a strand, wherein a yarn impregnated with a mineral suspension is introduced into the concrete strand as reinforcement. An extruder is known from CN 104 014 793 A, which is intended for 3D printing of metal.

It is therefore helpful to provide an additive manufacturing method and an additive manufacturing device which enable reliable, in particular layer-by-layer, construction of an object without significantly impairing existing areas of the object.

### SUMMARY

We thus provide a method for the additive manufacturing of an object, including the steps: supplying a strand-shaped starting material to a friction arrangement, and accelerating the starting material along an output direction through the friction arrangement to apply the starting material, in particular in layers, to a construction platform and/or to already manufactured areas of the object for manufacturing the object, wherein the strand-shaped starting material is at least partially liquefied and/or at least partially plasticized and/or at least partially broken down into particles by the friction arrangement.

We also provide a manufacturing device for the additive manufacturing of an object, including a friction arrangement to which a strand-shaped starting material can be supplied, wherein the friction arrangement is configured to accelerate the starting material along an output direction to apply the starting material, in particular in layers, to a construction platform and/or to already manufactured areas of the object for manufacturing the object, wherein the friction arrangement is configured to at least partially liquefy the strand-shaped starting material and/or at least partially plasticize it and/or at least partially break it down into particles.

### BRIEF DESCRIPTION OF THE DRAWINGS

Further details, advantages and features are shown in the following description of examples based on the drawing. The Figures show in:

FIG. 1 is a schematic view of a component with reinforcement during additive manufacturing.

FIG. 2 is a first schematic view of a manufacturing device according to an example.

FIG. 3 is a second schematic view of the manufacturing device according to the example.

FIG. 4 is a first schematic detailed view of a friction arrangement of the manufacturing device according to the example.

FIG. 5 is a second schematic detailed view of a friction arrangement of the manufacturing device according to the example.

FIG. 6 is a third schematic detailed view of a friction arrangement of the manufacturing device according to the example.

FIG. 7 is a fourth schematic detailed view of a friction arrangement of the manufacturing device according to the example.

FIG. 8 is a fifth schematic view of a manufacturing device according to the example with tilting angles.

FIG. 9 is a principle sketch of the friction blasting process using the manufacturing device according to the example.

FIG. 10 is a schematic view of the manufacturing method of a component with reinforcement during an additive manufacturing method.

FIG. 11 is a schematic view of a manufacturing device according to an alternative example with a friction disk.

FIG. 12 is a schematic view of a manufacturing device according to a further alternative example with a friction disk and support roller.

### LIST OF REFERENCE CHARACTERS

1 Manufacturing device
2 Friction arrangement
3 First friction disk
4 Second friction disk
5a First drive device
5b second drive device
6a first shaft
6b second shaft
7 Heating device
8 Preheating device
9 Concrete dispenser
10 Object
10a Reinforcement
11 Starting material
12 Construction platform
12a Surface
13 Component
14 Process zone
15 Construction area
16 Wire supplying mechanism
17 Material beam
18 Binder dispenser
19 Support roller
100 Output direction
200 Rotational direction

### DETAILED DESCRIPTION

When “bottom” and “top” are mentioned herein, this describes the spatial assignments within the manufacturing device, the method and/or the figures. “Bottom” is closer to the center of the earth than “top”. A “bottom” is closer to the center of the earth than a “top”.

Preferably, the Cartesian coordinate system applies, with the x and y directions preferably extending within the plane of the construction platform and the z-axis pointing vertically upwards. When speaking of an angle α, this denotes a rotation around the z-axis, with β a rotation around the x-axis, and with γ a rotation around the y-axis.

When “friction disks” are mentioned herein, this refers in particular to any type of machine element that has an at least largely rotationally symmetrical design. The “friction disks” are configured in particular to convert kinetic energy into frictional heat through friction against each other and/or against another body, such as a supplied starting material for additive manufacturing. Preferably, one “friction disk” or at least two “friction disks” are configured to put the supplied starting material into a state that enables the material to be accelerated when it leaves the friction arrangement. One or at least two “friction disk(s)” can be configured in any possible diameter and/or effective diameter. Friction disks can be cylindrical, conical, spherical and/or have other rotationally symmetrical geometries.

When “conical friction disks” are mentioned herein, this refers in particular to any type of at least largely rotationally symmetrical machine elements which are not cylindrical in their geometry. “Conical friction disks” can be configured in any angle or angle combination and any diameter that is useful for the method and device. Angles of the friction surfaces between 0° and 90° in relation to the axis of rotation of the “conical friction disks” can be represented. “Conical friction disks” are also to be understood as friction disks which have an at least partially convex or concave contour, at least in the region of the friction surface. Alternatively or additionally, “conical friction disks” may also be referred to herein as “conically configured friction disks” or “friction disks with a conical design” or a similar wording and are to be understood accordingly in the same sense.

In this context, a “friction surface” is to be understood in particular as that area of a friction disk in which a deliberately induced frictional contact is accompanied by heat development or in which a significant action between a strand-shaped starting material and the friction disk takes place at least predominantly. A “friction surface” can be smooth or relatively smooth, such as a polished surface, or can have a deliberate roughness. A “friction surface” can have at least locally arranged surface structures that can promote frictional contact. Such surface structures can, for example, be configured as elevations, such as small pyramids. A “friction surface” can be a surface coating of a friction disk or an interchangeable element for application, in particular for segmented application, to a friction disk.

A “friction arrangement” comprises one, two or more rotatable/rotating friction disk(s) which come or are in contact with the strand-shaped starting material.

An “effective diameter” is the diameter or diameter range of at least one friction disk at which at least one friction surface is formed, i.e. at which the friction disk comes into frictional contact with the starting material.

In particular, “starting material” means any material in a solid initial state which can be converted into a plastic and/or molten state by the application of frictional energy and/or can be broken down into particles. A starting material can be a metal, an alloy, a polymer or a material compound, such as a combination of a polymer and fibers. A “starting material” can basically consist of any material and any combination of materials which is suitable for being able to be formed into a strand shape at least within certain sections and for being used with at least one, two or more friction disk(s).

A “strand-shaped starting material” is preferably round in cross-section with preferred diameters between 0.25 mm and 50 mm, or for example, between 0.5 mm and 15 mm. In some examples, the strand-shaped starting material has outer diameters between 1 mm and 10 mm, preferably between 1.5 mm and 8 mm and particularly preferably between 2 mm and 6 mm. The cross-section can also have other shapes such as an oval, a triangle, a square, a polygon or a star shape, wherein the circumference is preferably between 0.25 mm and 50 mm or, for example, between 0.5 mm and 15 mm. A “strand-shaped starting material” can also be configured as a tube, for example, as a round tube or as a rectangular tube, i.e. it can have a recess/recess which extends along the longitudinal direction of the “strand-shaped starting material”. A “strand-shaped starting material” can have a length of a few centimeters up to several kilometers if it can be stored on or in appropriate arrangements or processed in another way. A “strand-shaped starting material” can be produced from any starting material as well as from a combination of starting materials in various processes. For example, it may be made from two or more materials by coextrusion and/or it may be modified with nanoparticles. A “strand-shaped starting material” can also have a coating.

The “construction area” is at least one area within the manufacturing device in which heated or hot, accelerated particles are decelerated on impact with a surface and preferably form a positive and/or material bond with the material of the surface.

A “process zone” is the area within a friction arrangement in which the strand-shaped starting material is in direct contact with at least one friction disk and/or is in the immediate or (close) area to at least one friction disk and is heated and/or accelerated in the process. A direct or (close) area to a friction disk may include radial distances and/or material-free distances to the effective diameter of a few hundredths of a millimeter up to a few millimeters, for example, up to 4 mm distance or in some examples up to 8 mm distance. “Immediate” can also be understood in the context to mean minimal or very small spatial and/or temporal distances.

In particular, a “construction platform” is any type of substrate and/or any type of surface which is suitable for receiving starting material mentioned herein. In certain examples, a “construction platform” may be flat or nearly flat. In other examples, it may have an uneven surface configuration. In some examples, a “construction platform” may have locally different textures and/or consist of different materials. A “construction platform” can be formed from solid or predominantly solid material or consist of soft and/or loose components, such as granular fills. A “construction platform” may also comprise or be a liquid. In certain examples, a “construction platform” may have a smooth or a rough surface. In certain examples, it may also be formed in different planes. In some examples, a “construction platform” may comprise a coating and/or be subjected to a pre-treatment.

In particular, an “object” is a part or structure in any form and made of any material which can be manufactured using the method and/or device. Parts or areas of an entire component or assembly are also to be understood as an “object”. In particular, an “object” is preferably formed to a large extent from a metal or a polymer material or contains at least larger proportions of one of these.

A “component” is, in particular, any physical structure which can be manufactured, at least in components, using the method and/or apparatus. A “component” is preferably a combination of concrete and at least one metal. In some examples, a “component” may be a combination of at least one metal and at least one polymer. For example, an object and/or a semi-finished product comprising at least one metal may be further processed with at least one polymer by the apparatus and/or method. In some examples, an object and/or a semi-finished product made of metal, such as a steel or a nickel-based alloy, can be processed with at least one further metal by the device and/or the method, such as by applying a further metal such as copper or a copper alloy, e.g. for the manufacture of heat exchangers or for rocket combustion chambers.

A “semi-finished product” can be any type of raw material that does not yet correspond to the final object and/or the final component, preferably not yet corresponding to the final geometry or the final shape. For example, mechanically worn components or machine elements can be processed according to the invention and are to be understood herein as “semi-finished product”.

A “material jet” describes the material of a starting material and its condition in an area between the friction surface or the process zone and the construction platform or an object or semi-finished product. A “material jet” preferably consists of very fast, hot particles formed from the material of the starting material. These particles can have different shapes and sizes, ranging from a few micrometers to the millimeter range. In some examples, a “jet of material” corresponds at least partially or predominantly more in shape to a continuous (closed) complex of material, comparable to a jet of water, instead of isolated particles that would be comparable to water droplets in the context. In other words, at corresponding, generally very high feed rates of the strand-like starting material, the fast and hot particles can lie so close or close to each other that they have an at least partially closed shape or contour when viewed optically, preferably over the entire length of the “material jet”, with the major difference to the strand-like starting material that the speed can be orders of magnitude faster, such as at least 50 times, or even at least 250 times as fast as the feed rate of the starting material.

An “output direction” describes the movement trajectory of an output material, particularly in the area between the friction surface or the friction arrangement and the construction platform or in the area between the friction surface and the object. In its geometric configuration, an “output direction” can at least approximately form a line, or describe a more or less flat or three-dimensional spread. The projected material beam of an “output direction” can at least predominantly represent a point or a circular surface or an at least partially elliptical shape or assume any other geometric shape. The projected material beam of an “output direction” can also have the cross-sectional shape of a tube. The projected material jet of an “output direction” can be more or less geometrically undefined and thus be more comparable to the impact behavior of shot pellets. The movement trajectory of an “output direction” can also have a twist and thus correspond at least in part to a helix. Starting from the friction surfaces, the direction vectors of an “output direction” preferably intersect the surface of the construction platform and/or parts of the object. An “output direction” is oriented in particular in the direction of the construction platform and/or a semi-finished product to be machined and can preferably assume an angle of 0° to 90° in relation to a perpendicular of the construction platform or a semi-finished product.

“Concrete” refers in particular to material mixtures composed of an aggregate (from rocks such as sand, gravel or aggregates from other materials such as glass, clay or wood), a binder such as cement, as well as water and possibly other additives. The binder is mainly inorganic and/or mineral, such as cement, geopolymer or magnesia binder. The term “concrete” also includes mortar or fine-grain concrete, which is usually defined as such by the choice of a maximum grain size of 4 mm or less.

When the term “component from concrete” or a similar term is used herein, this preferably refers to a component that can preferably be produced at least in part by additive manufacturing and comprises previously defined material mixtures corresponding to the term “concrete”. Additive manufacturing methods can be: Concrete extrusion, an additive discharge by concrete dispensing, other depositing or spraying processes and, in particular, selectively binding particle bed processes such as SCA or SPI. SCA stands for “Selective Cement Activation” and means that a binder is provided in a particle bed, wherein selective binding takes place using an activator such as water. In this way, a concrete layer of any shape can be produced. SPI stands for “Selective Paste Intrusion” and means that the particle bed is selectively bound with a liquid binder. In both instances, a particle bed is initially provided, wherein areas of the particle bed that have not set must be removed after setting.

“Reinforcement” refers in particular to the reinforcement of components (made of concrete, for example) to increase their load-bearing capacity. The load-bearing capacity of a component can be specifically influenced anisotropically by “reinforcement”. A “reinforcement” preferably absorbs tensile stresses within the component. A “reinforcement” can consist of metal, steel, plastic, glass or carbon. A “reinforcement” can be bar-shaped, wire-shaped, in the form of a fiber, mat or textile/knitted fabric. A “bar-shaped reinforcement” or a “wire-shaped reinforcement” can be straight, curved or follow a direction of force. A “bar-shaped reinforcement” or a “wire-shaped reinforcement” can also include fibers.

If method steps are mentioned herein, the device or the control device is configured in some examples to carry out one, several or all of these method steps, in particular if these are automatically executable steps, in any combination, or to corresponding devices, which are preferably based by name on the designation of the respective method step (e.g. “determining” as a method step and “device for determining” for the device, etc.) and which can also be part of the device(s) or be connected thereto in a signal connection. e.g. “detecting” as a method step and “device for detecting” for the device, etc.) and which may also be part of the device(s) or be connected thereto in signal connection.

When used herein to refer to programmed or configured, these terms may be interchangeable in some examples.

Where reference is made herein to a signal or communication connection between two components, this may be understood to mean a connection that exists in use. It can also mean that there is a preparation for such a signal connection (wired, wireless or implemented in another way), for example, by coupling the two components, for example, by pairing, etc.

Pairing is a process that takes place in the context of computer networks to establish an initial link between computer units for the purpose of communication. The best-known example of this is the establishment of a Bluetooth connection, by which various devices (e.g. smartphone, headphones) are connected to each other. Pairing is sometimes also referred to as bonding.

The object is achieved by a method for the additive manufacturing of an object, comprising the following steps: First, a strand-shaped starting material is supplied to a friction arrangement. The supply is affected in particular by the friction arrangement and/or by an (additional) supply device. The friction (between the supplied starting material and the friction arrangement or parts thereof) within the friction arrangement preferably causes the starting material to heat up, as a result of which it preferably loses its strand shape. Finally, the output material is accelerated along an output direction by the friction arrangement. This allows the starting material to be applied, in particular in layers, to a construction platform and/or to already manufactured areas of the object for manufacturing the object.

The strand-shaped starting material is at least partially liquefied and/or at least partially plasticized and/or at least partially broken down into particles by the friction arrangement. The kinetic energy imparted by the acceleration of the starting material is preferably used to produce a connection between the starting material and already manufactured areas of the object. The starting material is preferably applied by a form-fit connection, in particular mechanical crimping, due to the kinetic energy of the accelerated starting material and a deformation when it hits the construction platform or the already manufactured areas of the object and/or by a material-fit connection with already manufactured areas of the object, in particular due to melting of the starting material and/or the already manufactured areas of the object. Preferably, the build-up, in particular the layer structure and/or the material bond, is achieved by a combination of heat of fusion and kinetic energy and/or by a combination of thermal and kinetic energy. In some examples, the kinetic energy is the dominant energy in the process. In this way, additive manufacturing can be achieved with a simple and inexpensive manufacturing device that achieves an optimal bond within the manufactured object. In addition, the kinetic energy of the starting material after heating in the friction arrangement preferably results in only minimal heat input into the object and/or into a semi-finished product during production, which in particular prevents or at least reduces damage to the object or, if the object is part of a composite body, to other components of the composite body. In particular in comparison to arc welding, the heat input can be reduced, wherein a moderate heat input can also be maintained depending on the design of the acceleration. Finally, in some examples, the friction arrangement enables rapid heating and thus a high material throughput, which leads to high speeds during build-up, especially during layer build-up.

According to any one example, the friction arrangement heats the starting material by friction.

The friction arrangement at least partially liquefies and/or at least partially plasticizes and/or at least partially breaks down the strand-shaped starting material into particles. The melt and/or the particles produced in this way are then accelerated by the friction arrangement to exhibit kinetic energy in addition to the or a thermal energy. If the starting material is not liquefied by the friction arrangement, in some examples, liquefaction and/or plasticization can also be achieved by impacting the already manufactured areas of the object by selecting the appropriate kinetic energy. Alternatively, the choice of kinetic energy can prevent a melt from forming on impact and the particles from sticking to each other due to mechanical forces caused by their deformation on impact.

It is preferable for the friction arrangement to be heated. Heating is advantageously achieved by inductive heating of the friction arrangement. Alternatively or additionally, the friction arrangement is preferably heated by inductive heating of adjacent machine elements that introduce heat into the friction arrangement. In this way, the heat introduced into the friction arrangement by heating can be introduced into the starting material to increase the thermal energy in the starting material. Together with the kinetic energy of the starting material, a higher total energy can thus be provided to reliably bond the starting material to already manufactured areas of the object.

The starting material is preferably preheated during the supply. Preheating is affected particularly advantageous immediately before reaching the friction arrangement. This reduces the thermal energy to be introduced by the friction arrangement to melt the starting material. Preheating is preferably carried out by inductive heating of the starting material. For this purpose, for example, a coil can be provided through which or past which the strand-shaped starting material is passed before it reaches the friction arrangement. Additionally or alternatively, the starting material can be preheated using other forms of energy. Resistance heaters, radiation heaters,

Plasma, microwaves, lasers or other forms of heating can be used, such as the supply of thermal energy through friction.

Advantageously, the friction arrangement provides for a material discharge of the starting material of at least 5 kg/h, preferably at least 10 kg/h, particularly preferably at least 20 kg/h. This leads to rapid production of the object due to rapid build-up, in particular layer build-up. Large or many objects can therefore be produced in a short time. The method can also be used to manufacture objects that are part of a composite component, wherein other components of the composite component are and/or have been manufactured using other manufacturing methods, in particular other additive manufacturing methods. Due to the rapid manufacturability of the object, a delay in the manufacture of the composite component due to long manufacturing times of the object is thus avoided.

In an advantageous example, the object is produced from different starting materials. This is preferably done either by supplying different starting materials to the same friction arrangement simultaneously or successively. Alternatively or additionally, several friction arrangements are provided to which different starting materials are supplied, wherein all friction arrangements are provided for the production of the same object. The kinetic energy input in particular results in a large number of options for applying areas or layers of different materials to produce the object. Preferably, different steels, steels and copper as well as nickel and copper can be combined in this way. Alternatively, other materials such as different plastics can be combined with each other, with metallic materials or with other materials.

An advantageous example provides for a component to be additively manufactured by applying mineral and/or inorganic building material, in particular concrete and/or mortar that has not yet completely set, to a surface in layers and/or by producing mineral and/or inorganic building material, in particular concrete and/or mortar, on a surface in layers. Preferably, ready-mixed concrete or mortar is dispensed during the application process. When producing concrete or mortar in layers, the concrete is mixed in a particle bed only at the desired locations to produce the layer, for example, by selectively binding particle bed processes and/or the selective addition of water or another activator. Furthermore, an object is produced by a method as described above, wherein the object may preferably be a reinforcement within the component which is produced during additive manufacturing of the component by a method. The component thus represents a composite of concrete and reinforcement, which can be produced as a whole by additive manufacturing, in particular without one of the components being prefabricated. This allows different geometries to be produced. It can be advantageous if the layer-by-layer construction of the reinforcement takes place a few layers in advance of the layer-by-layer construction of the concrete, or if this takes place in reverse order.

This disclosure also relates to a manufacturing device for the additive manufacturing of an object. The manufacturing device comprises a friction arrangement to which a strand-shaped starting material can be supplied. The starting material is preferably supplied by the friction arrangement itself and/or by an (additional) supply device. The friction arrangement is configured to accelerate the starting material along an output direction to apply the starting material, in particular in layers, to a construction platform and/or to a semi-finished product and/or to already manufactured areas of the object for manufacturing the object. The manufacturing device can therefore be used in particular to carry out a previously described method for the manufacturing of the object. The friction arrangement advantageously allows the strand-shaped starting material to be at least partially liquefied and/or at least partially plasticized and/or at least partially broken down into particles and/or heated. The manufacturing device allows the starting material to be applied by form-fit connection, in particular mechanical crimping, due to the kinetic energy of the accelerated starting material and a deformation on impact with the construction platform and/or a semi-finished product or with the already manufactured areas and/or by material-fit connection with already manufactured areas, in particular due to melting of the starting material. Preferably, the manufacturing device enables a build-up, in particular a layer build-up, through a combination of frictional heat and kinetic energy.

The manufacturing device preferably comprises a control device. The control device is in particular programmed to have or cause the method to be carried out in any example disclosed herein, for example, by control commands to the components and/or actuators required for this purpose, in particular as disclosed herein. The control device can be in signal communication with the required components for this purpose or be prepared for this purpose.

The control device can initiate the execution of all or substantially all method steps. The method can be carried out essentially or completely by the control device. It can be partially carried out by the control device, in particular those steps can be carried out by the control device which do not require or involve human intervention and/or provision. The control device can serve as a pure control device or also as a regulating device.

In some examples, the manufacturing device may alternatively or additionally achieve a material bond within the discharged starting material, such as a metal bond.

The friction arrangement preferably comprises at least one friction disk. In particular, the friction disk can be rotated by at least one drive device. The starting material can be applied to a friction surface of the friction disk to be accelerated and preferably also heated by friction. For this purpose, it is particularly preferred that at least the friction surface of the friction disk has a heat-resistant and/or wear-resistant surface and/or coating. Such a coating is particularly advantageously made of a ceramic material. Alternatively or additionally, the friction disk is preferably made at least in part from a heat-resistant and/or wear-resistant material, in particular from a ceramic material. Furthermore, it is particularly provided that an angular velocity of the friction disk can be adapted to a feed rate of the starting material along the friction arrangement. The angular velocity is set such that, in particular, a path velocity of that area of the friction disk which comes into contact with the starting material is greater by at least a factor of 10, preferably by at least a factor of 100, particularly preferably by at least a factor of 1000, than the feed rate of the starting material along the friction arrangement, such as by at least a factor of 200, by at least a factor of 300, by at least a factor of 400 or by at least a factor of 500. The path velocity is calculated by multiplying the angular velocity of the friction disk by the distance of the area that comes into contact with the starting material from the axis of rotation of the friction disk. The contact area of the friction disk can be viewed approximately as a point or an arc. In this way, optimum heating of the starting material can be achieved by friction.

Particularly preferably, the friction arrangement comprises a first friction disk and a second friction disk. In particular, the first friction disk and the second friction disk can be rotated in opposite rotational directions by at least one drive device. Particularly advantageously, each friction disk is assigned its own drive device and each friction disk can be brought into operative connection with the drive device assigned to it. The starting material can be passed between the friction surfaces of the first friction disk and the second friction disk to be accelerated and preferably also heated by friction. For this purpose, it is particularly preferred that at least the friction surfaces of the first friction disk and/or second friction disk have a heat-resistant and/or wear-resistant surface and/or coating. Such a coating is particularly advantageously made of a ceramic material. Alternatively or additionally, the first friction disk and/or second friction disk are preferably at least partially made of a heat-resistant and/or wear-resistant material, in particular of a ceramic material. Furthermore, it is provided in particular that an angular velocity of the first friction disk and/or the second friction disk can be adapted to a feed rate of the starting material along the friction arrangement. The angular velocity is set such that, in particular, a path velocity of that area of the first friction disk and/or the second friction disk which comes into contact with the starting material is greater by at least a factor of 10, preferably by at least a factor of 100,particularly preferably by at least a factor of 1000, than the feed rate of the starting material along the friction arrangement, such as, for example, by at least a factor of 200, by at least a factor of 300, by at least a factor of 400 or by at least a factor of 500. The path velocity is calculated by multiplying the angular velocity of the first friction disk and/or second friction disk by the distance of the area that comes into contact with the starting material from the axis of rotation of the respective friction disk. The contact area of the first friction disk and/or the second friction disk can be viewed approximately as a point or an arc. In this way, optimum heating of the starting material can be achieved by friction. The angular velocities of the first friction disk and the second friction disk preferably have at least approximately the same value. In an advantageous example, the angular velocities of the first friction disk and/or the second friction disk are adjusted during the method and are thus variable and not constant. For example, it is intended to change the angular velocities of the two friction disks at least temporarily by a certain value.

Furthermore, it is particularly preferred that the at least one friction disk, in particular the first friction disk and/or the second friction disk, is or are at least partially conical. This allows optimum introduction of friction energy into the starting material and thus optimum heating of the starting material. Alternatively or additionally, the at least one friction disk or the first friction disk and/or the second friction disk can each be driven by a shaft. If several friction disks are provided, the respective shafts are preferably oriented non-parallel. This also leads, particularly advantageously together with the aforementioned conical design of the friction disk(s), to optimum heat input into the starting material. The friction arrangement thus preferably enables rapid heating of the starting material, which enables a high material throughput. Preferably, the angle between the two shafts of the two friction disks can be varied. This can be done statically, i.e. preferably before the start of additive manufacturing, or dynamically during processing with the described device.

Preferably, the distance between the two friction disks can be changed by a preferably axial adjustment option on the respective shafts. A corresponding adjustment mechanism can be provided on only one shaft as well as on both shafts. Such a primarily axial adjustment of at least one friction disk on the attached shaft can take place before and/or during the method.

The at least one friction disk, in particular the first friction disk and/or the second friction disk, is or are preferably heatable by at least one heating device. This takes place particularly advantageously by inductive heating and/or by heat input by heat radiation. By heating the at least one friction disk, in particular the first friction disk and/or the second friction disk, by a heating device, the friction energy required to heat the starting material is reduced. On the one hand, this leads to less wear of the friction arrangement and the starting material, and on the other hand, the starting material can be heated up more quickly, which enables a higher material throughput. In addition, a more uniform temperature level can be achieved in the method in this way, because the friction disks do not cool down, or at least do not cool down significantly, after the conveying of the strand-shaped starting material is stopped, as would be the case without additional heating of the friction disks.

The first friction disk and the second friction disk can advantageously be rotated at different speeds by the at least one drive device to generate a twist in the output starting material. In particular, the twist allows a movement trajectory of the output material to be stabilized after leaving the friction arrangement. This makes it possible to achieve greater accuracy in the production of the object.

In some examples, the speeds of two or more friction disks can be changed or adjusted to different speeds from each other during the method by a controller, preferably cyclically, cyclically repetitive or randomly within predetermined limit speeds.

Preferably, a friction surface is located on at least one flat surface and/or flat side of a friction disk. Alternatively or additionally, a friction surface is located on at least one circumferential surface of a friction disk. In certain examples, a friction surface of a friction disk can be configured at any conceivable angle with respect to an axis of rotation of the friction disk.

In some examples, at least one friction disk or friction disks are not or at least predominantly not conical and/or have at least substantially no friction surfaces that are conical, but are at least substantially cylindrical, so that the friction surfaces are formed at least predominantly on the circumferential surfaces of the friction disks.

In certain examples, three, four or more friction disks can be used, which can be configured with the features to form at least one friction arrangement or a part thereof in this way.

In some examples, the friction disks may have different diameters, geometries, surfaces and/or materials.

In certain examples, at least one friction disk of a friction arrangement has a rotational speed of over 1000 rpm, preferably over 5000 rpm and particularly preferably over 10,000 rpm during acceleration of starting material.

In some examples, at least one friction disk of a friction arrangement has a rotational speed of over 15000 rpm, preferably over 20000 rpm, particularly preferably over 30000 rpm and most preferably over 40000 rpm, such as over 50000 rpm, during acceleration of starting material.

In advantageous examples, the friction disks have diameters of at least 20 mm, preferably of at least 40 mm and particularly preferably of at least 55 mm, such as 60 mm or 70 mm.

In some examples, at least one friction disk has a diameter and/or an effective diameter of at least 75 mm, preferably of at least 100 mm, particularly preferably of at least 125 mm, and very particularly of at least 150 mm, such as between 80 mm and 160 mm or between 100 mm and 200 mm.

In some examples, an outer diameter of at least one friction disk can also be regarded at least approximately as the effective diameter within which a friction arrangement is formed.

In some examples, the friction disks may have significantly different rotational speeds from one another, such as a difference of at least 200 rpm, preferably of at least 1000 rpm and particularly preferably of over 3000 rpm, such as over 5000 rpm or over 10000 rpm.

It is particularly advantageous to provide a preheating device that is used to preheat the starting material before it reaches the friction arrangement. This reduces the heating power to be applied by the friction arrangement. Preheating is carried out in particular by inductive heating, for example, by guiding the strand-shaped starting material through or past a coil. By reducing the heating power of the friction arrangement, which is generated by friction energy, stress/wear on the friction arrangement and the starting material can be reduced due to the reduced friction.

In certain examples, for example, when processing aluminum or copper alloys with high thermal conductivity, it can be advantageous to cool the strand-shaped starting material preferably directly before the feed area of the friction disks. Such cooling can be achieved by passing the strand-shaped starting material through a tube and ensuring that the radial distance from the strand-shaped starting material to the tube has the smallest possible clearance in diameter. Such a tube is preferably provided with a cooling device extending around the circumference of the tube. In this way, heat can be dissipated from the extruded starting material, thus preventing premature softening of the same. In another example, the tube described for cooling the strand-shaped starting material has a certain amount of play in relation to it, so that a gap—in particular an annular gap when viewed in cross-section of the tube-is formed between the starting material guided through the tube and the inner wall of the tube facing the starting material. Compressed air or inert gas such as nitrogen can be supplied through this gap and thus achieve directional cooling of the strand-shaped starting material.

The device may comprise a control/regulating device that can be used to control or regulate technical parameters such as speeds, feed rates, distances between the friction disks, temperatures of the friction disks and temperature of the strand-shaped starting material as well as other parameters.

In certain examples, the temperature of the conveyed or accelerated starting material can preferably be measured in the area between the friction disks and the construction platform or the object, preferably using an infrared thermometer.

Preferably, for the manufacturing method and/or manufacturing device described above, it is provided that the starting material is a metal wire, a plastic in strand form or a composite material in strand form. Starting material in strand form is particularly cheaper to purchase and use than, for example, starting material in powder or granulate form. By using the friction arrangement to heat the starting material, the manufacturing device and/or the manufacturing method can be easily adapted to a different starting material to be used. For this purpose, the friction power to be generated is preferably adjusted by the friction arrangement, for example, by the speed of the friction disks and/or the feed rate of the starting material and/or the distance between the friction disks and/or the angular position of the friction disks relative to each other and/or the temperatures of the starting material and/or the friction disks.

In some examples, several strand-shaped starting materials can also be used simultaneously. In other words, for example, two strand-shaped starting materials made of different materials can be supplied at least temporarily to a friction arrangement comprising at least two friction disks at the same or different feed rates and heated and/or accelerated in this way. In this way, for example, a varying material matrix can be achieved on the object. For example, two semicircular, strand-shaped starting materials made of two different materials can be processed, which form at least approximately a circular contour due to a mirror-inverted arrangement when viewed in cross-section.

This disclosure also relates to the use of a manufacturing device as described above for the additive manufacturing of a reinforcement of a component. In particular, the reinforcement can be produced during additive manufacturing of the component, wherein the component is produced by applying mineral and/or inorganic building material, in particular concrete and/or mortar, in layers to a surface. Alternatively or additionally, the mineral and/or inorganic building material, in particular the concrete and/or mortar, can also be produced directly in layers. In particular, it should be understood here that the steps of producing the component in layers and the steps of producing the reinforcement in layers are carried out simultaneously or at staggered/interleaved times. This means that either one or more layers of the reinforcement and then one or more layers of the component can be produced alternately. Alternatively, layers of component and reinforcement can also be produced simultaneously. The additive manufacturing of reinforcement and component, without one of these components having to be completely prefabricated, creates a simple and cost-effective way of producing different geometries.

In some examples, a stranded starting material includes at least one metal such as aluminum, magnesium, copper, brass, bronze, iron, steel, structural steel, carbon steel, heat treatable steel, case hardening steel, stainless steel, tool steel, molybdenum, platinum, tantalum, niobium, titanium, gold, silver, bronze, nickel, chromium, tin, zinc, lead, and bismuth.

In some examples, a stream of material and/or at least components of a stream of material have a temperature of at least 500° C., preferably of at least 700° C., more preferably of at least 800° C. and most preferably of at least 900° C., such as between 500° C. and 1400° C., between 700° C. and 1600° C. or between 1000° C. and 1800° C., at least immediately after leaving the process zone.

In some examples, a jet of material has velocities of at least 50 m/s at least in parts and/or regions, preferably of at least 100 m/s, particularly preferably of at least 150 m/s and most preferably of at least 200 m/s.

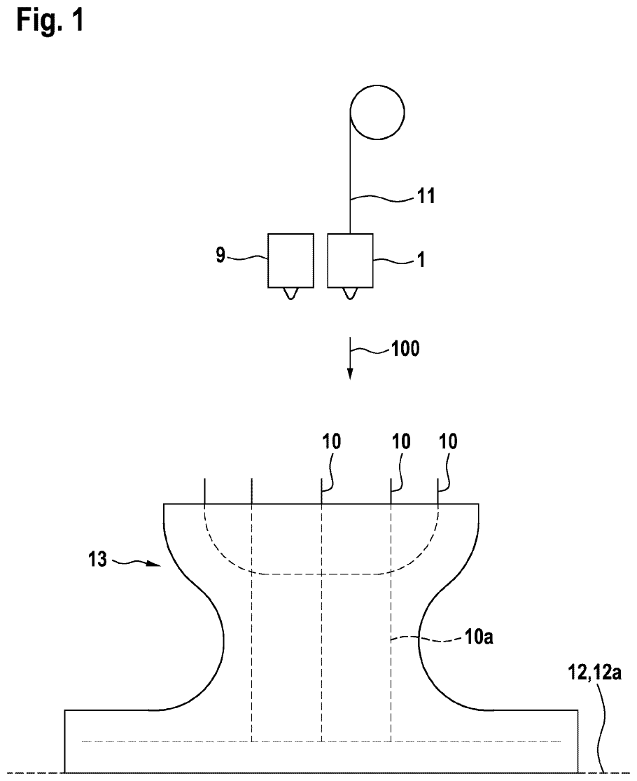

FIG. 1 schematically shows a manufacturing device 1 according to an example. The manufacturing device 1 is used for the additive manufacturing of an object 10 and comprises a friction arrangement 2 (not shown in FIG. 1), to which a strand-shaped starting material 11 is supplied, for example, by a supply device of any design (not shown). The strand-shaped starting material 11 is, for example, a metal wire. The object 10 can be built up by the manufacturing device 1, in particular in layers.

The friction arrangement 2 is used to heat the starting material 11 and to accelerate the starting material 11 along an output direction 100. The starting material is either melted or broken down into solid particles by the friction arrangement 2, wherein the starting material processed in this way impinges on a construction platform 12 or on areas of the object 10 that have already been manufactured. The manufactured areas of the object 10 are, in particular, already manufactured layers. In particular, the starting material 11 from the friction arrangement 2 can thus be output as a jet or as shot. The thermal energy and the kinetic energy of the starting material 11 are used to create a reliable bond with the already manufactured areas of the object 10 by hitting them. This is achieved, for example, by a material-locking and/or form-locking connection with the already manufactured area.

In the example shown in FIG. 1, it is intended to manufacture a component 13 from concrete, wherein the object 10 is a reinforcement for the component 13. The component 13 is additively manufactured by applying concrete, in particular in layers, by a concrete dispenser 9 to a surface 12a or to areas that have already been manufactured. Alternatively, the concrete can also be produced directly, in particular in layers, on the surface 12a or on areas that have already been produced. In this example, the surface 12a corresponds to the construction platform 12. The reinforcement is additively manufactured by the manufacturing device 1, wherein at least one or more layers of the reinforcement are always applied first and then at least one or more layers of the component 13. The component 13 and the reinforcement can thus be produced in variable shapes, so that flexibility in the production of components 13 with reinforcement is increased.

If the object 10 is a reinforcement as described above, a high surface quality of the object 10 is undesirable. Roughness, grooves and/or undercuts rather lead to an optimized bonding of the concrete to the reinforcement. However, the manufacturing device 1 also enables the production of objects 10 with a higher surface quality. The advantage of a reduced surface quality is that individual areas or layers can be finished quickly, which reduces the overall production time of the object 10 and therefore also of the component 13.

The friction arrangement 2 for heating and accelerating the starting material 11 makes the manufacturing device 1 very easy and cost-effective to manufacture. At the same time, objects 10 with high stability and quality can be produced quickly. The starting material 11 to be used for this purpose is strand-shaped and therefore cheaper than other types of starting materials such as powdered materials.

The combination of kinetic energy and thermal energy means that not all the energy required to build up a layer has to be provided by thermal energy. Waste heat during the production of a layer is therefore minimized. This is particularly advantageous in the reinforcement application described above, as heat input into layers of the concrete component 13 that have already been produced is minimized during the production of the reinforcement. If alternating layers of the concrete component 13 and the metal reinforcement are produced, the concrete is not yet fully hardened when the layers of reinforcement are produced. If too much waste heat were to occur during the production of the reinforcement, this would have a detrimental effect on the concrete, which is prevented by the manufacturing device 1.

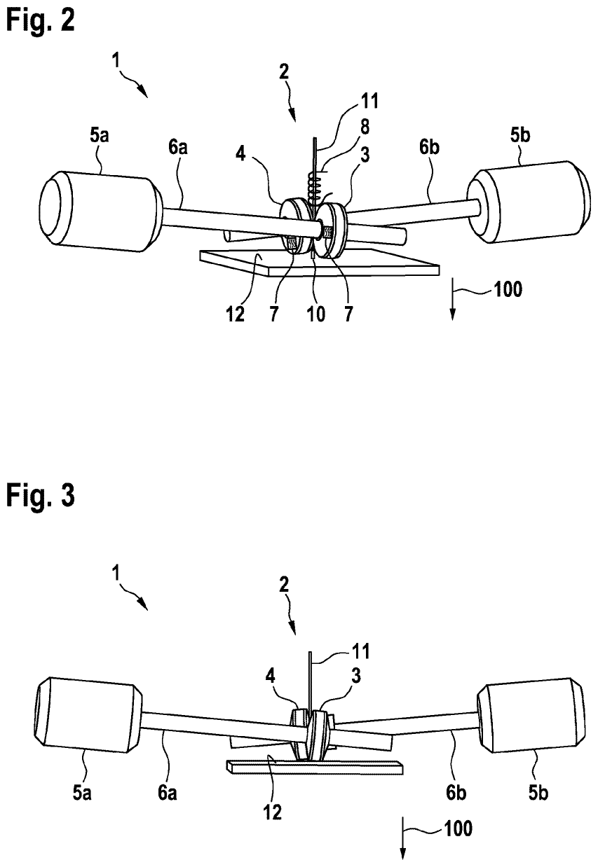

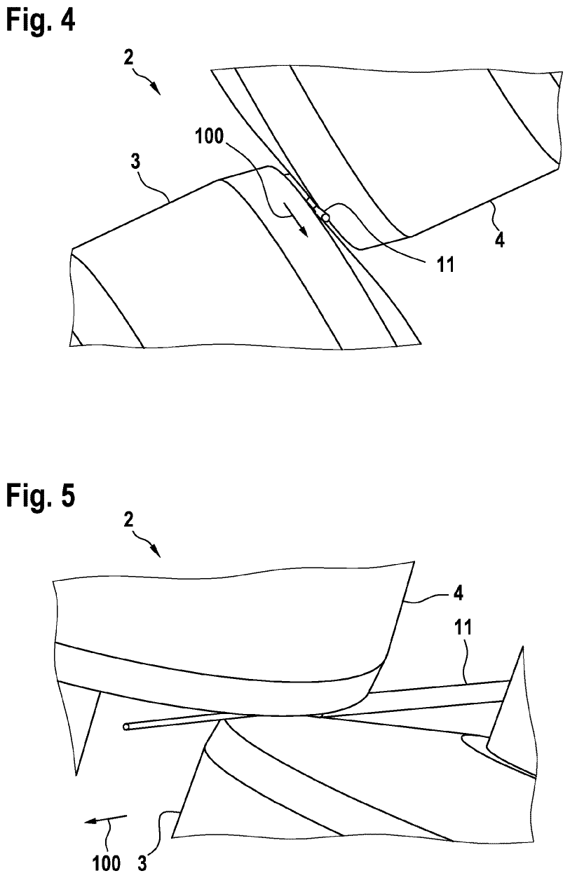

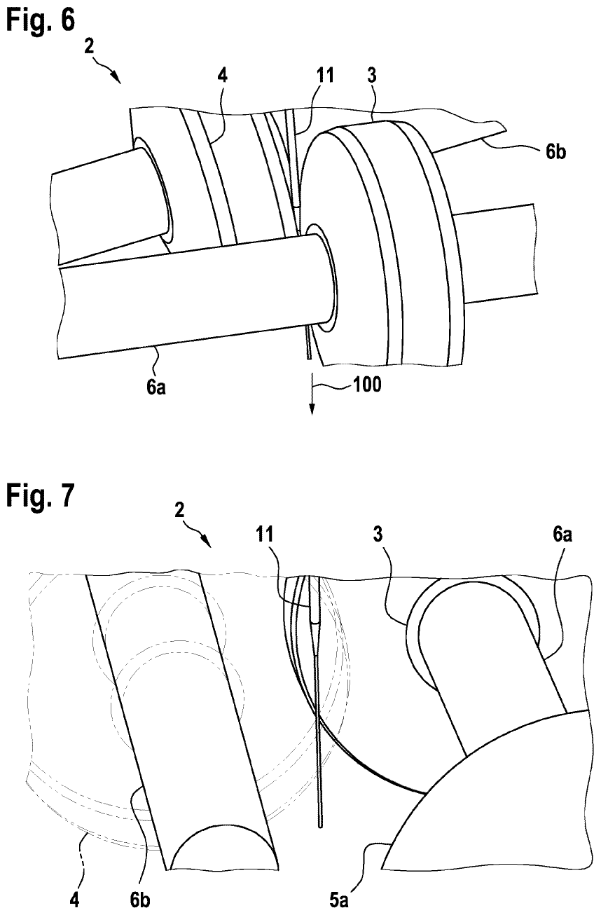

The structure of the friction arrangement 2 is shown in different views in FIGS. 2 and 3. FIGS. 4 to 7 show individual details of the friction arrangement 2. All these figures are described together below.

The friction arrangement 2 comprises a first friction disk 3 and a second friction disk 4. The first friction disk 3 is coupled to a first drive device 5a via a first shaft 6a, so that the first drive device 5a can rotate the first friction disk 3. Similarly, the second friction disk 4 is connected to a second drive device 5b via a second shaft 6b, so that the second drive device 5b can rotate the second friction disk 4. Alternatively, a common drive device can also be provided, which serves to drive both friction disks 3, 4 (not shown). It is intended that the first friction disk 3 and the second friction disk 4 preferably rotate in opposite rotational directions.

The strand-shaped starting material 11 is, for example, a metal wire or a strand-shaped plastic. If the starting material 11 is supplied to the friction arrangement 2, the starting material 11 is passed between the first friction disk 3 and the second friction disk 4, in particular between the friction surfaces of the first friction disk 3 and the second friction disk 4. This creates friction between the starting material 11 and the first friction disk 3 and the second friction disk 4, in particular between the starting material 11 and the friction surfaces of the first friction disk 3 and the second friction disk 4. The starting material 11 is particularly advantageously passed between the end faces of the first friction disk 3 and the second friction disk 4. For this purpose, the first friction disk 3 and the second friction disk 4 are rotated by the corresponding drive device 5a, 5b.

Passing the starting material 11 between the rotating first friction disk 3 and the rotating second friction disk 4 leads to heating of the starting material 11 and, in particular, to at least partial melting of the starting material 11. After the starting material 11 has passed the first friction disk 3 and the second friction disk 4, it is output as a molten jet or as an accumulation of solid particles, preferably as a material jet, along the output direction 100 to the construction platform 12. The starting material 11 is particularly advantageously brought to a higher temperature level by the first friction disk 3 and the second friction disk 4 and simultaneously accelerated in the output direction 100.

The friction energy to be applied can be adjusted by the angular velocities of the first friction disk 3 and the second friction disk 4 as well as by a feed rate of the starting material 11. It is preferable that the area of the first friction disk 3 and/or the second friction disk 4 that comes into contact with the starting material 11 moves around the axis of rotation of the respective friction disk 3, 4 at a speed that is greater than the previously described feed rate of the starting material 11 by at least a factor of 10, preferably by at least a factor of 100, particularly preferably by at least a factor of 1000. These parameters allow the friction arrangement 2 to be optimally adapted to the starting material 11 to be used.

It is particularly advantageous for the first friction disk 3 and the second friction disk 4 to have different angular velocities. This introduces a twist into the starting material 11. This twist ensures stabilization of the movement trajectory of the starting material 11 after it leaves the friction arrangement 2 until it hits the construction platform 12 or the already manufactured areas of the object 10.

In this way, predeterminable shapes of the object 10 can be produced as accurately as possible. In particular, the surface quality of the object 10 can be optimized.

The first friction disk 3 and the second friction disk 4 are preferably conical in shape. In particular, a thickness of the first friction disk 3 and/or the second friction disk 4 measured along the respective axis of rotation of the friction disks 3, 4 decreases in the radial direction. Alternatively or additionally, the first shaft 6a and the second shaft 6b and thus the associated axes of rotation of the first friction disk 3 and the second friction disk 4 are oriented at an angle to one another (and thus aligned non-parallel). This makes it possible to optimize a contact surface with which the friction disks 3, 4 bear against the starting material 11 and heat the starting material 11 by friction.

The first friction disk 3 and/or the second friction disk 4 are preferably made of a heat-resistant and/or wear-resistant material, in particular a ceramic material. Alternatively or additionally, the first friction disk 3 and/or the second friction disk 4 have a heat-resistant and/or wear-resistant coating, which is advantageously made of a ceramic material. This minimizes wear on the friction arrangement 2 and maximizes the durability/lifetime of the friction arrangement 2.

The friction device 2 allows the starting material 11 to be heated quickly and reliably. A material discharge of the starting material 11 from the friction arrangement 2 is thus maximized. Preferably, a material output of at least 10 kg/h, more preferably at least 20 kg/h and particularly preferably at least 25 kg/h is provided. This means that the objects 10 can be manufactured with high performance.

Furthermore, it is preferred that the starting material 11 is preheated immediately before reaching the friction arrangement 2. The preheating is carried out by a preheating device 8 (see FIG. 2) and preferably by inductive heating of the starting material 11. In the example shown in FIG. 2, the preheating device 8 is a coil through which the starting material 11 is passed. If an electric current flows through the coil of the preheating device 8, a current is induced in a metallic starting material 11, which leads to heating of the starting material 11. This means that less friction power has to be generated by the friction arrangement 2 to achieve the same temperature level of the starting material 11 as without the preheating device 8. On the one hand, this reduces the overall heating time and, on the other hand, ensures a lower load on the friction arrangement 2.

It is also preferable for the first friction disk 3 and/or the second friction disk 4 to be heated via at least one heating device 7. Inductive heating is also preferred here, as this does not require any physical contact between the heating device 7 and the friction disks 3, 4. By heating the first friction disk 3 and/or the second friction disk 4, the required friction power of the friction arrangement 2 is reduced, which in turn results in a higher heating speed and/or a lower load on the friction arrangement 2.

The friction arrangement 2 can also be used to process different starting materials 11 into a single object 10. For example, steels and copper or even nickel and copper can be combined easily and with little effort to produce an object 10 from multi-materials. The processing of plastic, in particular high-performance plastic such as PEEK, can also be implemented easily and with little effort using the manufacturing device 1 to produce corresponding objects 10. Such plastics can advantageously also be reinforced with short fibers. If short fibers are provided within the starting material 11, these can preferably be oriented along the output direction 100, since the kinetic energy of the heated starting material 11 after acceleration causes the short fibers to have a pinning effect when they hit layers of the object 10 that have already been produced. This means that the short fibers in the output direction 100 “get stuck” in the layer that has already been produced and thus maintain their alignment along the output direction 100. This leads to increased bonding between successive layers of the object 10.

In addition to the aforementioned application for the production of reinforcements, for which only a relatively coarse accuracy is required, the manufacturing device 1 described above can also be used for other applications, since in particular a diameter of up to 0.5 mm can be achieved for the beam emitted by the friction arrangement 2 on the starting material 11.

In addition to the above written description, explicit reference is hereby made to the graphic representation in FIGS. 1 to 7 for its supplementary disclosure.

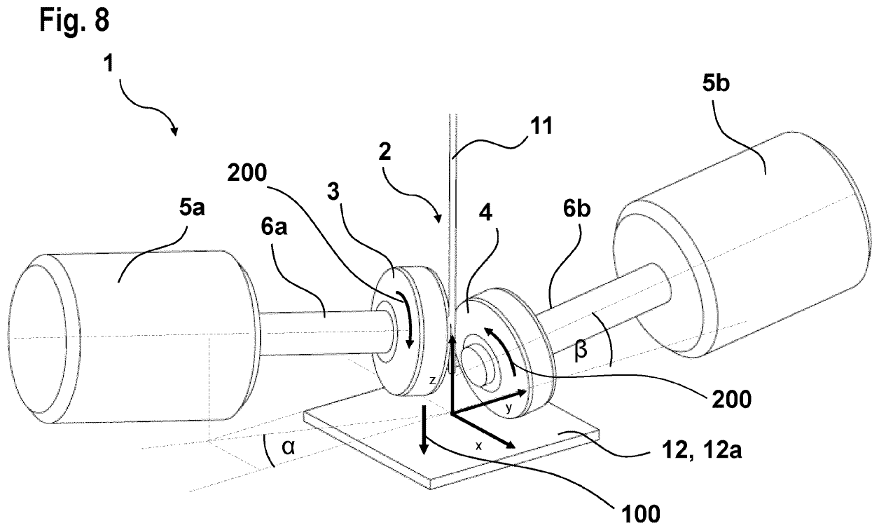

FIG. 8 shows a further illustration of the manufacturing device 1 with the friction arrangement 2. The first friction disk 3 and the second friction disk 4 are conical, although in some examples (not shown) they may differ in their angles and diameters. In the illustrated FIG. 8, the first friction disk 3 and the second friction disk 4 are identical in their geometry. The axes of rotation of the first friction disk 3 and the second friction disk 4 can be parallel or at least partially parallel to a construction platform surface 12a, or they can have predetermined angular positions, as shown as an example in FIG. 8. A first angle α describes a rotation or tilting in a first direction, which rotates about a z-axis. The second angle β describes a rotation or tilting in a second direction, with the angle β extending between the surface 12a of the construction platform 12 and the axis of rotation of the friction disk 3 and/or the friction disk 4. The angles α and β can be applied independently of one another. Thus, at least one of the friction disks 3, 4 can be rotated or tilted only by an angle α or only by an angle β, or one friction disk 3, 4 or both friction disks 3, 4 can be rotated or tilted by both angles. A rotation or tilting can either be fixed by the manufacturing device 1 due to its mechanical structure, or such a rotation or tilting is adjustable, preferably executable by at least one control unit, and particularly preferably in response to at least one parameter. The angle α preferably comprises values between 0° and 90°. The angle β preferably comprises values between 0° and 45°. An angle β can optionally be replaced by an angle γ to achieve tilting about the y-axis. In some examples, the first friction disk 3 and the second friction disk 4 have different angles α and/or angles β in relation to one another, such as differing by up to 5°, preferably differing by up to 15° and particularly preferably differing by up to 30°.

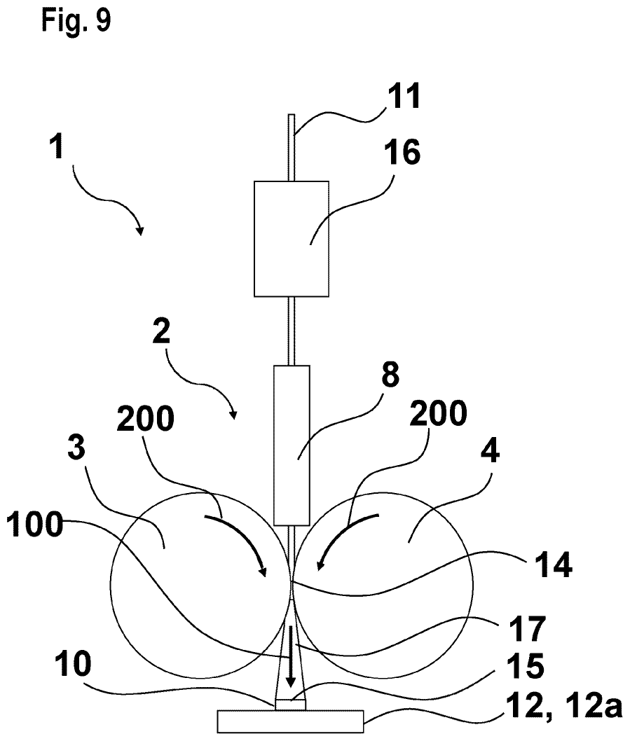

FIG. 9 shows a schematic diagram of the friction blasting process according to an example of the manufacturing device 1. The manufacturing device 1 is used for additively manufacturing an object 10 and comprises a friction arrangement 2 to which a strand-shaped starting material 11 is supplied, for example, by an arbitrarily configured wire supplying mechanism 16 or another means for supplying strand-shaped starting material 11 in a predetermined manner. The strand-shaped starting material 11 is, for example, a metal wire, e.g. of a certain steel alloy for a steel reinforcement. The object 10 can be built up by the manufacturing device 1, in particular in layers.

The friction arrangement 2 is used to accelerate the starting material 11 along an output direction 100 and preferably to heat the starting material 11. A friction arrangement 2 basically consists of at least one friction disk rotating in the rotational direction 200. In the schematic diagram shown in FIG. 9, the first friction disk 3 and the second friction disk 4 rotate in opposite rotational directions 200.

The strand-shaped starting material 11 is either heated, melted and/or broken down into solid particles by the friction arrangement 2. The disintegration and/or acceleration and/or heating of the starting material 11 takes place in the process zone 14. The resulting material jet of preferably hot, very fast particles 17 is preferably output as a granular material jet and/or in shot form and moves in the output direction 100. This material jet strikes either the construction platform 12, a defined surface 12a, the uppermost object layer of the object 10 and/or a semi-finished product.

By hitting the construction area 15 on already manufactured areas of the object 10, the thermal energy and the kinetic energy of the (accelerated) starting material 11 are used to create a reliable connection to the already manufactured areas of the object 10. A new object layer 10a is created. This connection is made, for example, by a material-locking and/or form-locking connection with the already manufactured area of the object 10.

According to the example shown in FIG. 9, the starting material 11 is preheated immediately before reaching the friction arrangement 2. The preheating is carried out by a preheating device 8, preferably by inductive heating of the starting material 11. In an inductively configured preheating device 8, an electric current flows through at least one coil (not shown), through which a metallic, strand-shaped starting material 11 is passed. In this way, a current is induced in a metallic starting material 11, preferably within a steel wire, which leads to heating of the starting material 11. The preheating device 8 can alternatively or additionally be configured differently, for example, by at least one resistance heating device and/or by at least one heat radiation device.

By using a preheating device 8, less friction power has to be applied by the friction arrangement 2 to reach the same temperature level of the starting material 11 as without a preheating device 8. On the one hand, this can reduce the overall heating time and, on the other hand, ensure a lower load on the friction arrangement 2.

It is also preferable that the first friction disk 3 and/or the second friction disk 4 is/are heated via at least one heating device 7 (not shown in FIG. 9). Inductive heating is also preferred here, as this does not require any physical contact between the heating device 7 and the friction disks 3, 4. By heating the first friction disk 3 and/or the second friction disk 4, the required friction power of the friction arrangement 2 is reduced, as the friction disks 3, 4 are preferably already brought to the required and/or predetermined process temperatures. This in turn results in higher heating speeds of the starting material 11 and/or a lower load on the friction arrangement 2.

In addition to the aforementioned application for the production of reinforcements, where only a relatively coarse accuracy is required, the manufacturing device 1 can also be used for other applications, since, for example, a diameter of less than 1 mm and preferably less than 0.5 mm can be achieved for the beam of starting material 11 emitted by the friction arrangement 2.

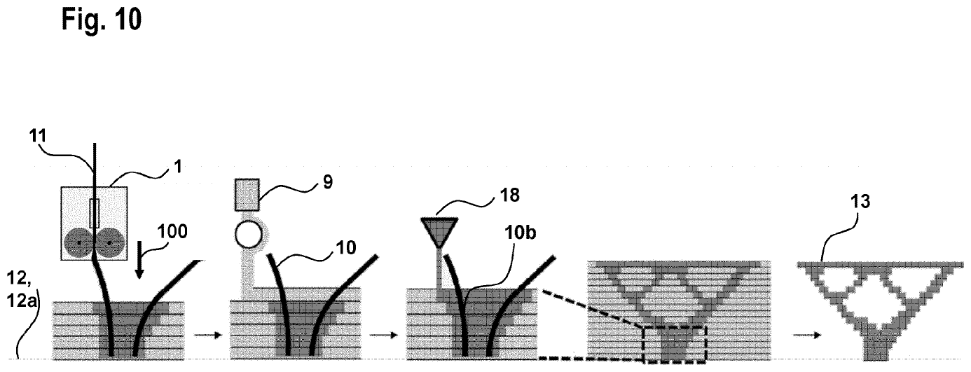

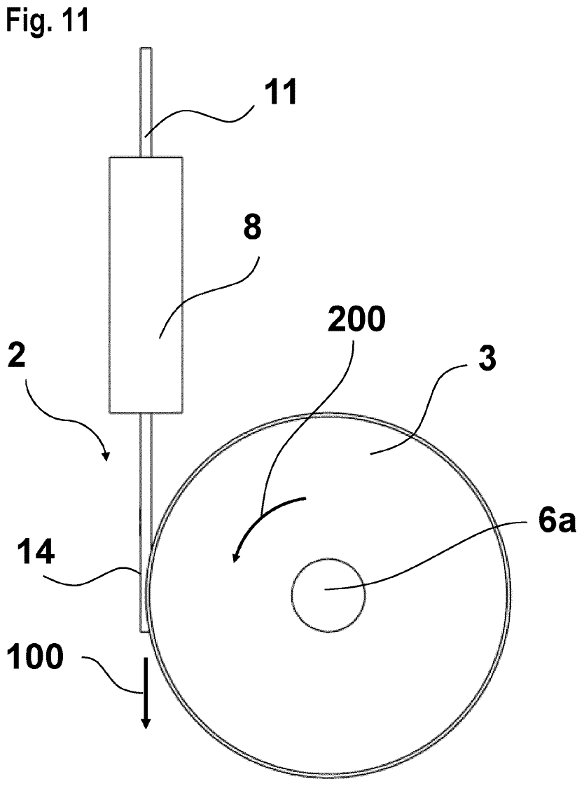

FIG. 10 shows in more detail the additive manufacturing of a component 13 made from concrete, into which a reinforcement 10a is installed during the construction process with the aid of a manufacturing device 1. The reinforcement 10a is additively manufactured by the manufacturing device 1, wherein preferably first one or more layers of the reinforcement 10a and then one or more layers of the component 13 are applied. The component 13 and the reinforcement 10a can thus be produced in variable shapes, so that flexibility in the production of components 13 with reinforcement 10a is increased.

To build up the component 13 in layers, the concrete dispenser 9 is first used to spread pourable material onto a construction platform 12 or surface 12a, which is selectively mixed with binder in the next step using a binder dispenser 18 or activator dispenser. This causes the material to solidify at these points and the component 13 is formed. During the construction process, the component 13 is embedded in free-flowing material, which must then be removed. There are other methods for applying concrete in layers using concrete 3D printing, such as extrusion processes (not shown), which are also suitable for inserting reinforcement 10a.

The wire-shaped starting material 11, from which the object 10 (or the reinforcement 10a) is manufactured, is supplied to the manufacturing device 1. The material jet is ejected in the output direction 100 and forms a bond with the object layer of the object 10. The object 10 preferably always protrudes at least one or preferably several layers out of the concrete so that the object 10 can cool down and the concrete is not thermally stressed as much in this way. The object 10 is preferably installed in the component 13 in layers, wherein it becomes the reinforcement 10a. If the object 10 is a reinforcement 10a as described above, a high surface quality of the object 10 is preferably undesirable. Roughness, grooves and/or undercuts rather lead to an optimized bonding of the concrete to the reinforcement 10a. Furthermore, structures can also be specifically created on the surface to improve the bond between the reinforcement and the surrounding concrete. The structures can preferably be similar to ribs on reinforcing bars, but can also take on other geometric shapes that improve the bond.

However, the manufacturing device 1 also enables the production of objects 10 with a higher surface quality. The advantage of a reduced surface quality is that individual areas or layers can be finished quickly, which reduces the overall production time of the object 10 and thus also of the component 13. The friction arrangement 2 for heating and/or accelerating the starting material 11 makes the manufacturing device 1 very easy and cost-effective to manufacture. At the same time, objects 10 with high stability and quality can be produced quickly. The starting material 11 used is in the form of a strand and is therefore less expensive than other types of starting materials, such as powdered materials.

The combination of kinetic energy and thermal energy means that not all of the energy required to build up a layer has to be provided by thermal energy. Waste heat during the production of a layer is thus minimized. This is particularly advantageous in the previously described application of the reinforcement 10a, as heat input into already produced layers of the concrete component 13 is minimized during the production of the reinforcement 10a. If alternating layers of the component 13 made of concrete and the reinforcement 10a made of metal are produced, the concrete is preferably not yet fully cured when the layers of reinforcement 10a are produced. If too much waste heat were to occur during the production of the reinforcement 10a, this would have a detrimental effect on the concrete, which is at least largely prevented by the manufacturing device 1.

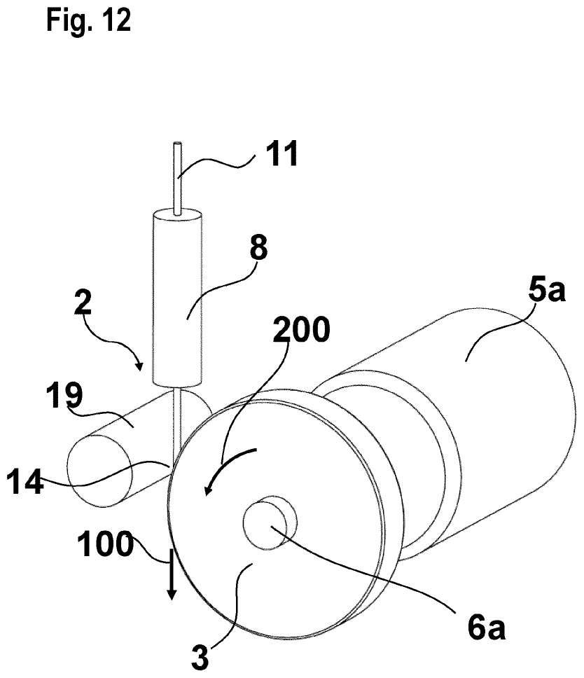

FIG. 11 shows a friction arrangement 2 with only one friction disk 3. In this example, starting material 11 in the form of 2 strands is supplied to the friction arrangement by a conveyor mechanism not shown. In particular, the conveyor mechanism presses the starting material 11 against the friction disk 3. The starting material 11 is preheated in a preheating device 8, as in the friction arrangements described above. The friction disk 3 is driven by a shaft 6a and the associated drive device 5a (not shown) and rotates in the rotational direction 200. In the process zone 14, the friction disk 3 heats the starting material 11 and discharges the accelerated material in the discharge direction 100.

FIG. 12 also shows a friction arrangement 2 with only one friction disk 3, which basically corresponds to the example shown in FIG. 11. In the example shown, the strand-shaped starting material 11 is guided and supported by a support roller 19 in the process zone 14. For precise guidance, particularly in the axial direction of the support roller 19, this can be equipped with a groove or a V-groove (not shown) around the circumference, for example. The axial direction is in particular orthogonal to the axis of rotation or along the circumferential surface of the support roller 19. The support roller 19 preferably rotates at least to some extent at the same circumferential speed as the conveying speed of the strand-shaped starting material 11, i.e. in particular much slower than the friction disk 3. The support roller 19 should preferably be arranged at least a little way upstream of the process zone 14 in relation to the strand-shaped starting material 11, so that the process conditions that occur, such as the very high temperatures, cannot have an unnecessarily negative effect on and/or damage the support roller 19. Optionally or additionally, instead of a supportR roller 19, other machine elements can also be used to guide and/or support strand-shaped starting material 11 on a friction disk 3.

The methods, devices, and uses disclosed herein are further described in the following clauses:
Clause 1. Method for the additive manufacturing of an object (10), comprising the steps: supplying a strand-shaped starting material (11) to a friction arrangement (2), and accelerating the starting material (11) along an output direction (100) through the friction arrangement (2) in order to apply the starting material (11), in particular in layers, to a construction platform (12) and/or to already manufactured areas of the object (10) for manufacturing the object (10), wherein the strand-shaped starting material (11) is at least partially liquefied and/or at least partially plasticized and/or at least partially broken down into particles by the friction arrangement (2).
Clause 2. Method according to clause 1, characterized in that heating the starting material (11) by the friction arrangement (2) is affected by friction.
Clause 3. Method according to any one of the preceding clauses, characterized in that the friction arrangement (2) is heated, wherein the heating is preferably affected by inductive heating of the friction arrangement (2) and/or preferably by inductive heating of adjacent machine elements which introduce heat into the friction arrangement (2).
Clause 4. Method according to any one of the preceding clauses, characterized in that the starting material (11) is preheated during the supply, in particular immediately before reaching the friction arrangement (2), wherein the preheating is preferably carried out by inductive heating of the starting material (11).
Clause 5. Method according to any one of the preceding clauses, characterized in that a material discharge of the starting material (11) of at least 5 kg/h, preferably of at least 10 kg/h, particularly preferably of at least 20 kg/h, is affected by the friction arrangement (2).
Clause 6. Method according to any one of the preceding clauses, characterized in that the object (10) is produced from different starting materials (11), in particular either by supplying different starting materials (11) to the same friction arrangement (2) simultaneously or successively and/or by providing a plurality of friction arrangements (2) to which different starting materials (11) are supplied, wherein all friction arrangements (2) are preferably provided for producing the same object (10).
Clause 7. Method according to any one of the preceding clauses, characterized in that a component (13) is additively manufactured by applying mineral and/or inorganic building material, in particular concrete and/or mortar, in layers onto a surface and/or by producing mineral and/or inorganic building material, in particular concrete and/or mortar, in layers onto a surface, wherein the object (10) preferably is a reinforcement (10a) within the component (13), which is produced during additive manufacturing of the component (13), in particular of concrete and/or mortar, on a surface, wherein the object (10) is preferably a reinforcement (10a) within the component (13), which is produced during the additive manufacturing of the component (13) by means of a method according to any one of the preceding claims.
Clause 8. Manufacturing device (1) for the additive manufacturing of an object (10), comprising a friction arrangement (2) to which a strand-shaped starting material (11) can be supplied, wherein the friction arrangement (2) is configured to accelerate the starting material (11) along an output direction (100) in order to apply the starting material (11), in particular in layers, to a construction platform (12) and/or to already manufactured areas of the object (10) for manufacturing the object (10), wherein the friction arrangement (2) is configured to at least partially liquefy the strand-shaped starting material (11) and/or at least partially plasticize it and/or at least partially break it down into particles.
Clause 9. Manufacturing device (1) according to clause 8, characterized in that the friction arrangement (2) comprises at least one friction disk (3, 4) which can be rotated by at least one drive device (5a, 5b) and wherein the starting material (11) can be applied to a friction surface of the friction disk (3, 4) in order to be accelerated and, in particular, heated by friction, and wherein, in particular, a path velocity of that region of the friction disk (3, 4) which comes into contact with the starting material (11) is greater by at least a factor of 10, preferably by at least a factor of 100, particularly preferably by at least a factor of 1000, than a feed rate of the starting material (11) along the friction arrangement (2).
Clause 10. Manufacturing device (1) according to clause 9, characterized in that the friction arrangement (2) comprises a first friction disk (3) and a second friction disk (4), wherein the first friction disk (3) and the second friction disk (4) can be rotated in opposite rotational directions by at least one drive device (5a, 5b), and wherein the starting material (11) can be passed between the friction surfaces of the first friction disk (3) and the second friction disk (4), in order to be accelerated, and in particular heated by friction, and wherein in particular a path velocity of that region of the first friction disk (3) and/or of the second friction disk (4) which comes into contact with the starting material (11) is greater by at least a factor of 10, preferably by at least a factor of 100, particularly preferably by at least a factor of 1000, than a feed rate of the starting material (11) along the friction arrangement (2).
Clause 11. Manufacturing device (1) according to clause 9 or 10, characterized in that the at least one friction disk (3, 4), in particular the first friction disk (3) and/or the second friction disk (4), is/are at least partially conical and/or can be driven via a respective shaft (6a, 6b), wherein the shafts (6a, 6b) are preferably oriented non-parallel.
Clause 12. Manufacturing device (1) according to any one of clauses 9 to 11, characterized in that the at least one friction disk (3, 4), in particular the first friction disk (3) and/or the second friction disk (4), is/are heatable by means of at least one heating device (7), in particular by inductive heating.
Clause 13. Manufacturing device (1) according to any one of clauses 10 to 12, characterized in that the first friction disk (3) and the second friction disk (4) can be rotated at different speeds by the at least one drive device (5a, 5b).
Clause 14. Manufacturing device (1) according to any one of clauses 8 to 12, characterized by a preheating device (8) which is configured for preheating the starting material (11) before reaching the friction arrangement (2), in particular by inductive heating.
Clause 15. Method according to any one of clauses 1 to 7, or manufacturing device (1) according to any one of claims 8 to 13, characterized in that the starting material (11) is a metal wire, a plastic in strand form or a composite material in strand form.
Clause 16. Use of a manufacturing device (1) according to any one of clauses 8 to 14 for additively manufacturing a reinforcement (10a) of a component (13), in particular during the additive manufacture of the component (13), by applying mineral and/or inorganic building material, in particular concrete and/or mortar, in layers on a surface and/or by producing mineral and/or inorganic building material, in particular concrete and/or mortar, in layers on a surface (12a).

1. A method for additive manufacturing of an object, comprising:
supplying a strand-shaped starting material to a friction arrangement, and
accelerating the starting material along an output direction through the friction arrangement to apply the starting material to a construction platform and/or to already manufactured areas of the object for manufacturing the object,
wherein the strand-shaped starting material is at least partially liquefied and/or at least partially plasticized and/or at least partially broken down into particles by the friction arrangement.

2. The method according to claim 1, characterized in that heating the starting material by the friction arrangement is effected by friction.

3. The method according to claim 1, wherein the friction arrangement is heated.

4. The method according to claim 1, wherein the starting material is preheated during the supply.

5. The method according to claim 1, wherein a material discharge of the starting material of at least 5 kg/h, is effected by the friction arrangement.

6. The method according to claim 1, wherein the object is produced from different starting materials either by supplying different starting materials to the same friction arrangement simultaneously or successively and/or by providing a plurality of friction arrangements to which different starting materials are supplied.

7. The method according to claim 1, wherein a component is additively manufactured by applying mineral and/or inorganic building material in layers onto a surface and/or by producing mineral and/or inorganic building material in layers onto a surface.

8. A manufacturing device for additive manufacturing of an object, comprising a friction arrangement to which a strand-shaped starting material can be supplied, wherein the friction arrangement is configured to accelerate the starting material along an output direction to apply the starting material, to a construction platform and/or to already manufactured areas of the object for manufacturing the object, wherein the friction arrangement is configured to at least partially liquefy the strand-shaped starting material and/or at least partially plasticize it and/or at least partially break it down into particles.

9. The manufacturing device according to claim 8, wherein the friction arrangement comprises at least one friction disk which can be rotated by at least one drive device and wherein the starting material can be applied to a friction surface of the friction disk to be accelerated and, heated by friction, and wherein a path velocity of that region of the friction disk which comes into contact with the starting material is greater by at least a factor of 10, than a feed rate of the starting material along the friction arrangement.

10. The manufacturing device according to claim 9, wherein the friction arrangement comprises a first friction disk and a second friction disk, wherein the first friction disk and the second friction disk can be rotated in opposite rotational directions by at least one drive device, and wherein the starting material can be passed between the friction surfaces of the first friction disk and the second friction disk, to be accelerated, and heated by friction, and wherein a path velocity of that region of the first friction disk and/or of the second friction disk which comes into contact with the starting material is greater by at least a factor of 10 than a feed rate of the starting material along the friction arrangement.

11. The manufacturing device according to claim 9, wherein the at least one friction disk is/are at least partially conical and/or can be driven via a respective shaft.

12. The manufacturing device according to claim 9, wherein the at least one friction disk is/are heatable by at least one heating device.

13. The manufacturing device according to claim 10, wherein the first friction disk and the second friction disk can be rotated at different speeds by the at least one drive device.

14. The manufacturing device according to claim 8, characterized by a preheating device which is configured for preheating the starting material before reaching the friction arrangement.

15. The method according to claim 1, wherein the starting material is a metal wire, a plastic in strand form or a composite material in strand form.

16. Use of a manufacturing device according to claim 8 for additively manufacturing a reinforcement of a component, comprising applying mineral and/or inorganic building material in layers on a surface and/or by producing mineral and/or inorganic building material in layers on a surface.

17. The use of claim 16, wherein the building material is selected from concrete, mortar, or combinations thereof.

18. The manufacturing device according to claim 8, wherein the starting material is a metal wire, a plastic in strand form or a composite material in strand form.
